(19) United States
(12) Patent Application Publication
(10) Pub. No.: US 2019/0068572 A1
(43) Pub. Date: Feb. 28, 2019

(54) CUSTOMIZABLE SECONDARY VERIFICATION IN A MULTI-TENANT SYSTEM

(71) Applicant: salesforce.com, inc., San Francisco, CA (US)

(72) Inventor: Mang Fu Matthew Wong, Castro Valley, CA (US)

(21) Appl. No.: 15/683,258

(22) Filed: Aug. 22, 2017

(51) Int. Cl. H04L 29/06

(52) U.S. Cl. CPC H04L 63/083; H04L 2463/082

(57) ABSTRACT

Techniques are disclosed relating to verifying access to functions in a multi-tenant computer system. In various embodiments, a multi-tenant computer system may store code that is executable to perform a plurality of functions, where at least one of the plurality of functions may be a restricted function. The multi-tenant computer system may further store first and second tenant-specific definitions for the restricted function that specify different secondary verification procedures. In various embodiments, the disclosed systems and methods may facilitate verifying access to the restricted function in the multi-tenant computer system. For example, in some embodiments, the multi-tenant computer system may perform an initial verification procedure and cause initiation of a secondary verification procedure specified by the first tenant in response to an attempt by a user of the first tenant to access the restricted function.

### BACKGROUND

### Technical Field

This disclosure relates generally to access verification, and more specifically to customizable secondary verification in a multi-tenant computer system.

### Description of the Related Art

A multi-tenant computer system may provide computing resources to numerous users associated with various tenants. For example, a multi-tenant computer system may include application servers configured to implement and execute software applications for, as well as provide related data, code, and other information to, users of the multi-tenant computer system. In some embodiments, data stored by the multi-tenant computer system may be arranged such that data of one tenant is kept separate from that of other tenants so that users associated with a first tenant do not have access to data of a second tenant, unless such data is expressly shared. In various embodiments, a multi-tenant computer system may provide various functionalities to users of various tenants of the multi-tenant computer system. For example, one function provided by the multi-tenant computer system may allow a user to generate database reports. In some embodiments, one or more of the functions provided by the multi-tenant computer system may be common to multiple tenants, such that one or more functions may be available to different users associated with different tenants of the multi-tenant computer system.

### BRIEF DESCRIPTION OF THE DRAWINGS

FIG. 1 is a block diagram illustrating an example multi-tenant computer system, according to some embodiments.

FIG. 2 is a block diagram illustrating example tenant-specific definitions of secondary verification procedures, according to some embodiments.

FIG. 3 is a flow diagram illustrating an example method for verifying access in a multi-tenant computer system, according to some embodiments.

FIG. 4 is a flow diagram illustrating an example method for verifying access to a restricted function, according to some embodiments.

FIG. 5 is a flow diagram illustrating an example method for determining whether to authorize access to a restricted function, according to some embodiments.

FIGS. 6A-6D illustrate an example implementation for specifying a secondary verification procedure, according to some embodiments.

FIG. 7 is a block diagram illustrating an example computer system, according to some embodiments.

### DETAILED DESCRIPTION

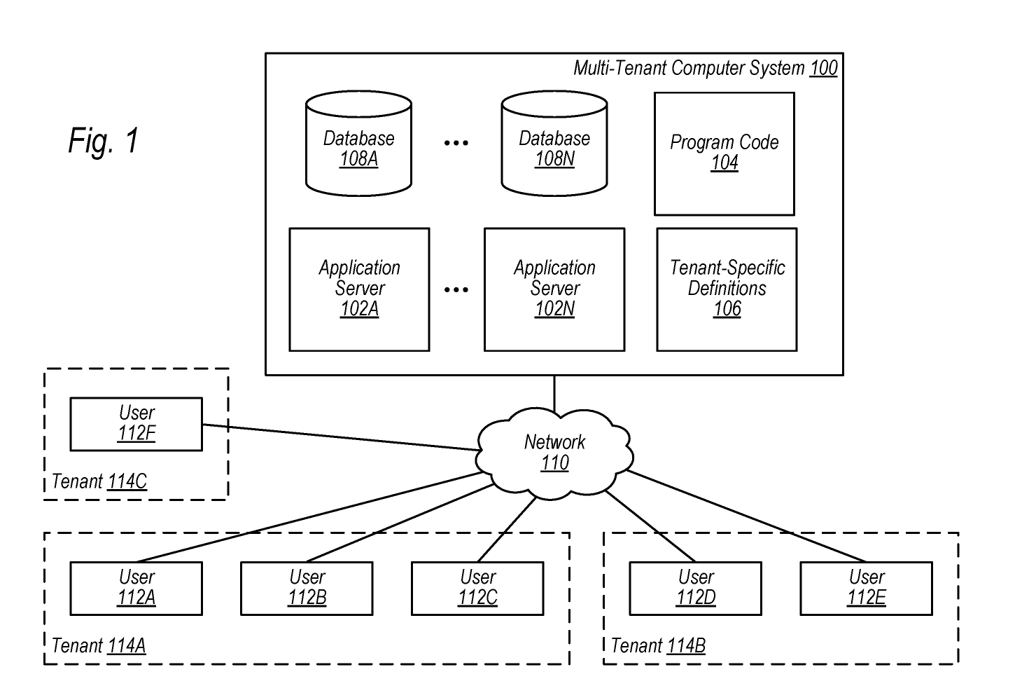

Referring to FIG. 1, a block diagram illustrating an example multi-tenant computer system (MTCS) 100 is shown, according to some embodiments. As shown in FIG. 1, MTCS 100 includes application servers 102, program code 104, tenant-specific definitions 106, and databases 108. In various embodiments, MTCS 100 may be configured to store program code 104 that is executable, for example by application servers 102, to implement a service that provides a variety of functions to one or more users 112 associated with various tenants 114. For instance, a user 112A associated with tenant 114A may access, via network 110, one or more functions provided by MTCS 100, for example as part of a software application hosted by an application server 102A of MTCS 100.

The functions available to a given user 112 may vary, for example based on the particular tenant 114 with which they are associated, their role within the tenant, etc. Consider, for example, tenant 114A with users 112A-112C. Each of users 112A-112C may have a different role within tenant 114A. For example, user 112A may be a system administrator, user 112B may be a software developer, and user 112C may be a salesperson. In such an embodiment, the functions provided by MTCS 100 available to a given user 112 may vary between users 112A-112C. For example, user 112A, the system administrator, may have access to a wide range of functions available via MTCS 100, such as the ability to manage user accounts, customize software applications, and generate database reports. User 112B, the software developer, may have access to a relatively-wide range of functions available via MTCS 100, such as the ability to customize software applications and generate database reports, but may not have access to other functions, such as managing user accounts. Further, user 112C, the salesperson, may have access to some functions available via MTCS 100, including generating database reports, but may not have access other functions, such as customizing software applications or managing user accounts.

MTCS 100 may provide various techniques to control access to the functions it provides. For example, some of the functions (e.g., managing user accounts, customizing software applications, etc.) may be considered restricted functions that require an initial verification procedure to be performed in response to an access attempt by a user 112. For example, in various embodiments, MTCS 100 may store account information associated with user accounts for users 112. This account information may include information specifying a set of permissions for the users, indicating which functions of MTCS 100 a given user 112 can access. In some embodiments, MTCS 100 may perform the initial verification procedure by performing a permissions check against the set of access permissions of the user attempting to access the restricted function, for example.

In various embodiments, one or more restricted functions provided by MTCS 100 may be available to users 112 associated with different tenants 114. For example, as shown in FIG. 1, user 112D is associated with tenant 114B. In one embodiment, user 112D may be a system administrator for tenant 114B and, like user 112A, have access to a wide range of functions available via MTCS 100, such as the ability to manage user accounts, customize software applications, and generate database reports. In such embodiments, these restricted functions would be available to users 112 of both tenant 114A and 114B. In various embodiments, the initial verification procedure implemented by MTCS 100 may be common to multiple tenants 114, such as tenants 114A and 114B, for example. That is, while a given user 112's ability to access a given restricted function of the MTCS 100 may vary (for example based on the given user 112's set of permissions), the manner of performing the initial verification procedure by MTCS 100 may be common across multiple tenants, in some embodiments. For example, in some embodiments, MTCS 100 may perform the same initial verification procedure when user 112C of Tenant 114A attempts to access a given restricted function as when a user 112D of tenant 114B attempts to access the given restricted function.

In various embodiments, tenants 114 may wish to implement additional security safeguards, beyond merely performing the initial verification procedure, for different functions of the MTCS 100. For example, for tenant 114A, the function that allows a user to customize software applications may be considered critical, and thus, as a policy, tenant 114A may wish to add additional security verifications to this function when users 112A-112C attempt to access it. For a different tenant (e.g., tenant 114B), however, this functionality may not be considered critical, and tenant 114B may not want to implement any additional safeguards beyond an initial verification procedure when users 112D-112E attempt to access that function. Tenant 114B may, however, consider a different function (e.g., the ability to schedule database reports) to be important to its operations and, therefore, want to implement additional security safeguards, beyond merely performing the initial verification procedure, when users 112D-112E attempt to access this function. Thus, in various embodiments, different tenants 114 of the MTCS 100 may desire to implement additional security verification procedures for different ones of the functions available to its respective users 112.

In various embodiments, tenants 114 may specify additional security verification procedures to implement for various functions. As shown in FIG. 1, MTCS 100 may store tenant-specific definitions 106 for various restricted functions, where the tenant-specific definitions 106 may specify a secondary verification procedure to implement for a given tenant 114 when a user 112 attempts to access a given function. For example, in the embodiment depicted in FIG. 1, MTCS 100 may store first and second tenant-specific definitions for a particular restricted function, such as managing user accounts. In this embodiment, the first tenant-specific definition may be associated with and specified by tenant 114A, and the second tenant-specific definition may be associated with and specified by tenant 114B. In general, the tenant-specific definitions 106 relate to parameters for verification of a restricted function, including whether there is a secondary verification procedure specified and, if so, the type of the secondary verification procedure and any predicate condition to performing this procedure.

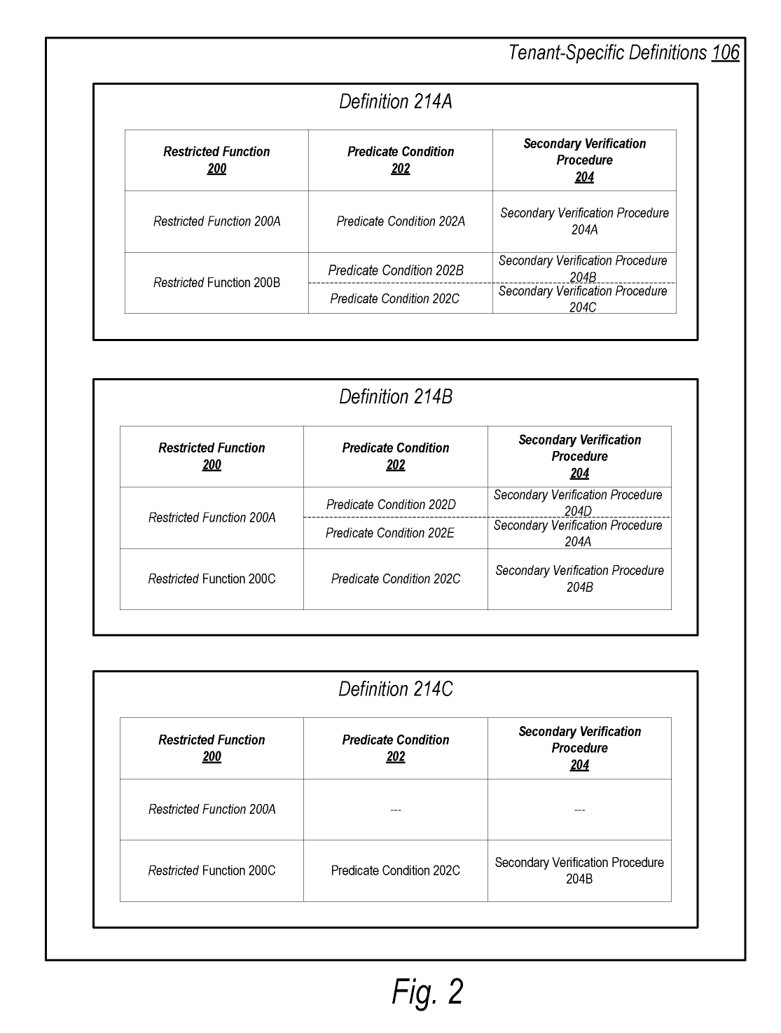

The tenant-specific definitions 106 may, in various embodiments, specify a predicate condition and a particular secondary verification procedure to be performed if the predicate condition is satisfied. For example, tenant 114A may, for a given restricted function (e.g., managing user accounts), specify in the first tenant-specific definition a predicate condition (e.g., a user 112 attempting to access the restricted function from a restricted IP address) and a secondary verification procedure (e.g., requiring a user 112 to answer a security question) to be performed if the predicate condition is satisfied. Further, for example, tenant 114B may, for a given restricted function (e.g., managing user accounts) specify in the second tenant-specific definition a predicate condition (e.g., a user 112 attempting to access the restricted function during a particular time period) and a secondary verification procedure (e.g., require a user 112 to provide authentication credentials) to be performed if the predicate condition is satisfied. Note, however, that these predicate conditions and secondary verification procedures are provided merely as examples and any suitable predicate condition or secondary verification procedure may be used, in various embodiments. Further, as described in more detail below with reference to FIG. 2, the particular predicate conditions or secondary verification procedures may vary, for example by tenant, by restricted function, etc.

Thus, in various embodiments, the tenant-specific definitions 106 may allow a given tenant 114 to specify both the predicate conditions under which a secondary verification procedure will be performed and the particular secondary verification procedure to perform when a predicate condition is met. For example, if user 112A attempts to access a given restricted function (e.g., manage user accounts), MTCS 100 may perform the initial verification procedure to determine whether user 112A has access to that given restricted function. If user 112A passes the initial verification procedure, MTCS 100 may determine whether any tenant-specific definitions 106 are stored for that given restricted function for tenant 114A. For example, as noted above, tenant 114A may specify, for the restricted function of managing user accounts, a first tenant-specific definition that includes a first predicate condition and a particular secondary verification procedure for tenant 114A to be performed in response to the first predicate condition being met. In such an embodiment, MTCS 100 may cause initiation of the particular secondary verification procedure in response to the first predicate condition being met.

Similarly, if user 112D attempts to access a given restricted function (e.g., manage user accounts), MTCS 100 may perform the initial verification procedure to determine whether user 112D has access to that given restricted function. If user 112D passes the initial verification procedure, MTCS 100 may determine whether any tenant-specific definitions 106 are stored for that given restricted function for tenant 114B. For example, as noted above, tenant 114B may specify, for the restricted function of managing user accounts, a second tenant-specific definition that includes a second predicate condition and a particular secondary verification procedure for tenant 114B to be performed in response to the second predicate condition being met. In such an embodiment, MTCS 100 may cause initiation of the particular secondary verification procedure in response to the second predicate condition being met.

Note that, in some embodiments, a secondary verification procedure may be implemented for a particular restricted function on a system-wide basis for all tenants 114 of MTCS 100. That is, in some embodiments, a given secondary verification procedure may be implemented when a user 112 of any tenant 114 attempts to access a given restricted function. For example, consider a situation in which an administrator of MTCS 100 wishes to add a secondary verification procedure to a restricted function that allows a user 112 to assign access permission sets, after learning of malware targeting this particular function. In such an embodiment, a secondary verification procedure may be implemented for all users 112 across all tenants 114 of MTCS 100.

The disclosed systems and methods may provide various improvements to the functioning of MTCS 100. For example, when introducing functions that will be accessible to users 112 of one or more tenants 114, system administrators of MTCS 100 may identify various functions for which access controls may be desirable (e.g., managing user accounts, etc.). Those functions, as noted above, may be restricted functions that require an initial verification procedure to be performed before providing a requesting user 112 with access to the restricted function. Using the systems and methods disclosed herein, tenants 114 of MTCS 100 may leverage the identification of potentially-sensitive restricted functions and specify tenant-specific definitions 106 for different ones of the restricted functions. As noted in more detail throughout this disclosure, in various embodiments, a tenant may specify, for a given restricted function, the particular predicate conditions and secondary verification procedures to implement in response to those predicate conditions being satisfied. This, in turn, may allow a given tenant 114 to implement additional, custom security verification procedures to restricted functions that are deemed to be sensitive, important, vulnerable, etc.

Turning now to FIG. 2, a block diagram of example tenant-specific definitions 106 is shown, according to some embodiments. In the embodiment shown in FIG. 2, tenant-specific definitions 106 include definitions 214A-214C, which may correspond to tenant-specific definitions respectively associated with and specified by tenants 114A-114C of FIG. 1.

As noted above, the tenant-specific definitions 106 may specify a secondary verification procedure to implement for a given tenant 114 when a user 112 attempts to access a given restricted function. For example, as shown in FIG. 2, tenant-specific definitions 106 may include definitions 214A-214C for tenants 114A-114C, respectively, of FIG. 1. Each of these definitions 214, in turn, may specify, for a plurality of restricted functions 200, predicate conditions 202 and secondary verification procedures 204 to implement in response to the predicate conditions 202 being met. For example, definition 214A may specify, for a given restricted function 200A, a predicate condition 202A and a secondary verification procedure 204A to perform if predicate condition 202A is met. Further, see definition 214C for example, which does not specify for restricted function 200A a secondary verification procedure 204 to perform if a predicate condition 202 is met.

Further, in various embodiment, a definition 214 may include multiple predicate conditions 202 or secondary verification procedures 204 for a given restricted function 200. For example, definition 214B specifies, for restricted function 200A, a predicate condition 202D and a particular secondary verification procedure 204D for tenant 114B to be performed if the predicate condition 202D is met. Additionally, definition 214B further specifies, for restricted function 200A, a second predicate condition 202E and another secondary verification procedure 204A for tenant 114B to be performed if the second predicate condition 202E is met. As demonstrated by definition 214, in such embodiments, one or more of the predicate conditions 202 or secondary verification procedures 204 may differ from one another for a given restricted function 200.

In various embodiments, the particular predicate condition(s) 202 and secondary verification procedure(s) 204 associated with a given restricted function 200 may be customizable by tenants 114, with each tenant 114 having the ability to specify the particular predicate conditions 202 and secondary verification procedures 204 to suit its needs. Accordingly, in such embodiments, the predicate conditions 202 and secondary verification procedures 204 associated with the restricted functions 200 may vary, for example by restricted function, by tenant, etc. For example, as shown in definition 214A, predicate condition 202 and secondary verification procedure 204 associated with restricted function 200A are different than the predicate conditions 202 and secondary verification procedures 204 associated with restricted function 200B for tenant 114A.

Further, in some embodiments, the predicate conditions 202 or secondary verification procedures 204 used by different tenants 114 may overlap. For example, with reference to restricted function 200A, definition 214A specifies that secondary verification procedure 204A is to be performed in response to predicate condition 202A being satisfied. In definition 214B, two pairs of predicate conditions 202 and secondary verification procedures 204 are specified. Specifically, definition 214 specifies that secondary verification procedure 204D is to be performed in response to predicate condition 202D being satisfied, and that secondary verification procedure 204A is to be performed in response to predicate condition 202E being satisfied. Thus, with regard to the predicate condition 202D-secondary verification procedure 204D pair, there is no overlap with definition 214A. With regard to the predicate condition 202E-secondary verification procedure 204A pair, however, definition 214B includes some overlap with definition 214A. That is, in the described embodiment, different predicate conditions 202 specified by different tenants 114 result in the same secondary verification procedure 204.

In various embodiments, a definition 214 may specify predicate conditions 202 and secondary verification procedures 204 for any, all, or none of the restricted functions 200 available to users 112 of a given tenant 114. For example, definitions 214A and 214B specify, for tenants 114A and 114B, respectively, predicate conditions 202 and secondary verification procedures 204 associated with restricted function 200A. In some embodiments, however, tenant 114C may choose not to specify a predicate condition 202 or secondary verification procedure 204 for restricted function 200A. Thus, in the depicted embodiment, definition 214C does not specify a predicate condition 202 or secondary verification procedure 204 associated with restricted function 200A, as shown in FIG. 2.

Note that, although only two restricted functions 200 are shown in in the definitions 214 of FIG. 2, this embodiment is provided merely as an example and is not intended to limit the scope of the present disclosure.

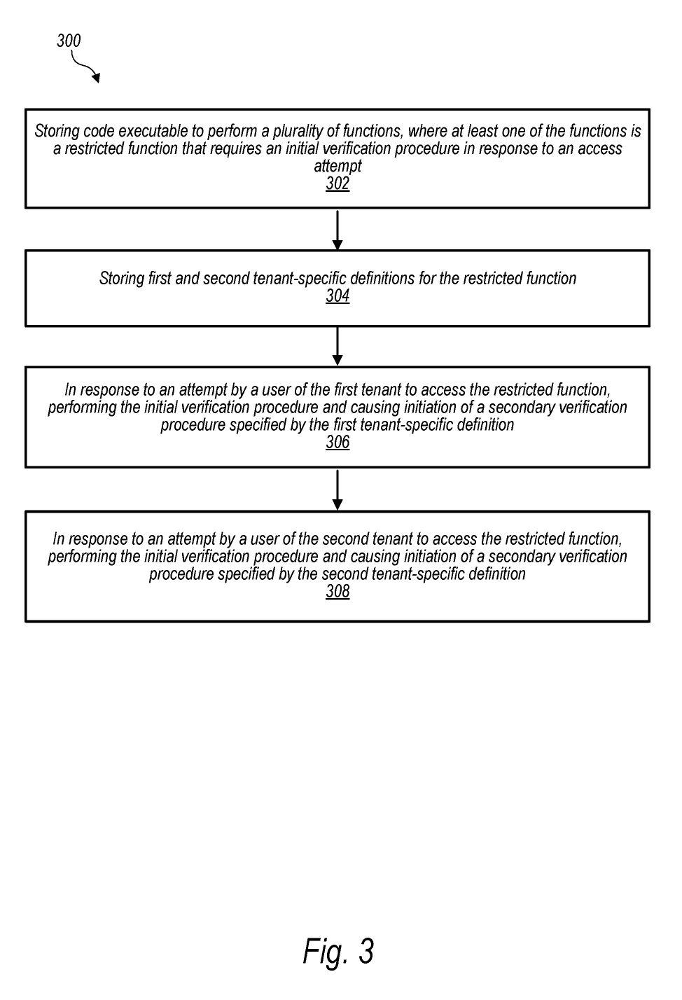

Referring now to FIG. 3, a flow diagram is shown of an example method 300 for verifying access to a restricted function in a multi-tenant computer system, according to some embodiments. In various embodiments, method 300 may be implemented, for example, by MTCS 100 of FIG. 1. FIG. 3 includes elements 302-308. While these elements are shown in a particular order for ease of understanding, other orders may be used. For example, in various embodiments, some of the method elements may be performed concurrently, in a different order than shown, or may be omitted. Further, additional method elements may also be performed as desired.

Element 302 includes storing code executable to perform a plurality of functions, where at least one of the functions is a restricted function that requires an initial verification procedure in response to an access attempt. For example, MTCS 100 may store program code 104 that, when executed by one or more application servers 102, implements a service that includes a plurality of functions, including one or more restricted functions. In response to an attempt to access one of these restricted function, for example by a user 112C, MTCS 100 may perform an initial verification procedure to determine whether user 112C has access to that restricted function. Further, as noted above, the initial verification procedure performed in response to an attempt to access a restricted function may be common to at least a first tenant and a second tenant of MTCS 100, such as tenant 114A and 114B, according to some embodiments.

Method 300 then proceeds to element 304, which includes storing first and second tenant-specific definitions for the restricted function. For example, MTCS 100 of FIG. 1 may store tenant-specific definitions 106 that specifies secondary verification procedures to perform when a user 112 attempts to access a given restricted function. As described above in reference to FIG. 2, tenant-specific definitions 106 may include definition 214A, which may be associated with and specified by tenant 114A, and definition 214B, which may be associated with and specified tenant 114B. In some embodiments, the first and second tenant-specific definitions may specify different secondary verification procedures.

Method 300 then proceeds to element 306, which includes, in response to an attempt by a user of the first tenant to access the restricted function, performing the initial verification procedure and causing initiation of a secondary verification procedure specified by the first tenant-specific definition. For example, consider an instance in which user 112A of tenant 114A attempts to access restricted function 200A. In response to user 112A's attempted access, MTCS 100 may perform an initial verification procedure for user 112A. Further, in response to user 112A satisfying the initial verification procedure, MTCS 100 may cause the initiation of a secondary verification procedure specified by definition 214A of tenant-specific definitions 106.

Method 300 then proceeds to element 308, which includes, in response to an attempt by a user of the second tenant to access the restricted function, performing the initial verification procedure and causing initiation of a secondary verification procedure specified by the second tenant-specific definition. For example, consider an instance in which user 112D of tenant 114B attempts to access restricted function 200A. In response to user 112D's attempted access, MTCS 100 may perform an initial verification procedure for user 112D. Further, in response to user 112D satisfying the initial verification procedure, MTCS 100 may cause the initiation of a secondary verification procedure specified by definition 214B of tenant-specific definitions 106.

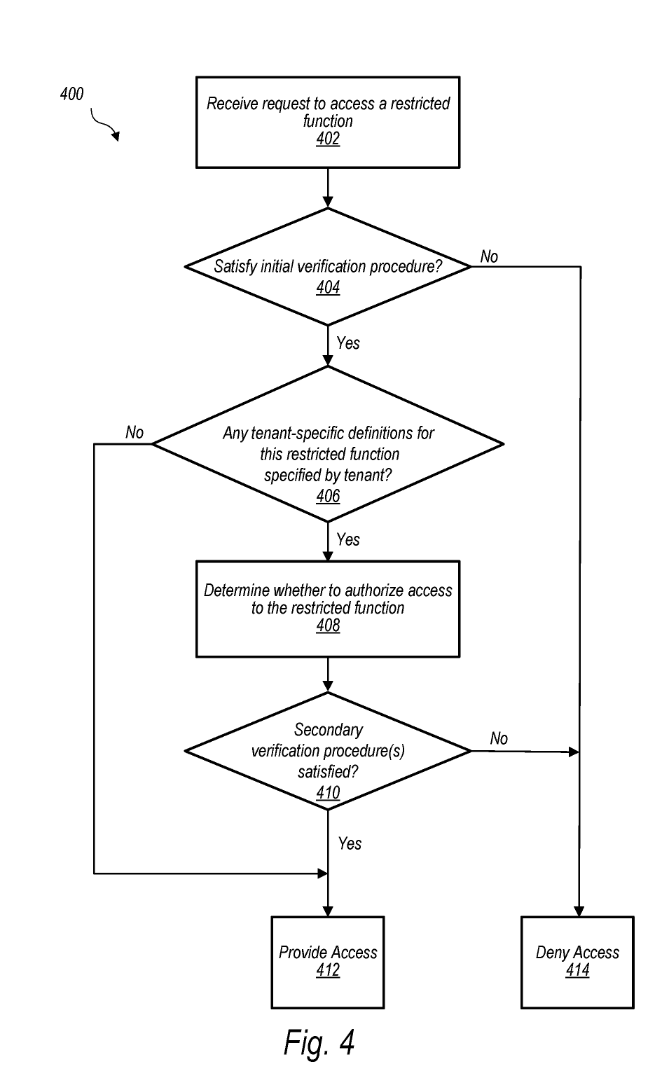

Turning now to FIG. 4, a flow diagram is shown of an example method 400 for verifying access to a restricted function in a multi-tenant computer system, according to various embodiments. Method 400 may be implemented, for example, by MTCS 100 of FIG. 1. FIG. 4 includes elements 402-414. While these elements are shown in a particular order for ease of understanding, other orders may be used. For example, in various embodiments, some of the method elements may be performed concurrently, in a different order than shown, or may be omitted. Further, additional method elements may also be performed as desired.

Element 402 includes receiving a request to access a restricted function. For example, MTCS 100 may receive a request from one of users 112A-112C of tenant 114A to access a restricted function 200A (e.g., generating a database report from database 108) provided by MTCS 100.

Method 400 then proceeds to element 404, which includes determining whether the initial verification procedure is satisfied. In some embodiments, as noted above, the initial verification procedure may include performing a permissions check against set of access permissions of the user 112 attempting to access the restricted function 200.

If the requesting user 112 does not satisfy the initial verification procedure at element 404, method 400 proceeds to element 414, which includes denying access to the restricted function. For instance, with reference to the example provided in FIG. 1, in response to user 112C, the salesperson, attempting to access the restricted function that allows customization of software applications, MTCS 100 may determine at element 404 that user 112C does not satisfy the initial verification procedure for that restricted function. In some embodiments, in response to the user 112 not satisfying the initial verification procedure, MTCS 100 will not cause initiation of any secondary verification procedure specified in the tenant-specific definitions 106. If, however, the requesting user 112 does satisfy the initial verification procedure (e.g., user 112B, the software developer, attempting to access the restricted function that allows customization of software applications), then method 400 proceeds to element 406.

Element 406 includes determining, for the tenant 114 of the requesting user 112, whether any tenant-specific definitions are specified for the restricted function. For example, MTCS 100 may check tenant-specific definitions 106 to see if there is secondary verification procedure 204 specified for the particular restricted function 200 for the relevant tenant 114. If there are not any tenant-specific definitions for the restricted function (e.g., restricted function 200A in definition 214C of FIG. 2), method 400 proceeds to element 412, which includes allowing access to the restricted function. For example, MTCS 100 may provide user 112F of tenant 114C with access to restricted function 200A without causing initiation of a secondary verification procedure based on user 112F satisfying the initial verification procedure and MTCS 100 determining that there is not a tenant-specific definition for restricted function 200A for tenant 114C. If, however, there are one or more tenant-specific definitions for the restricted function, method 400 proceeds to element 408.

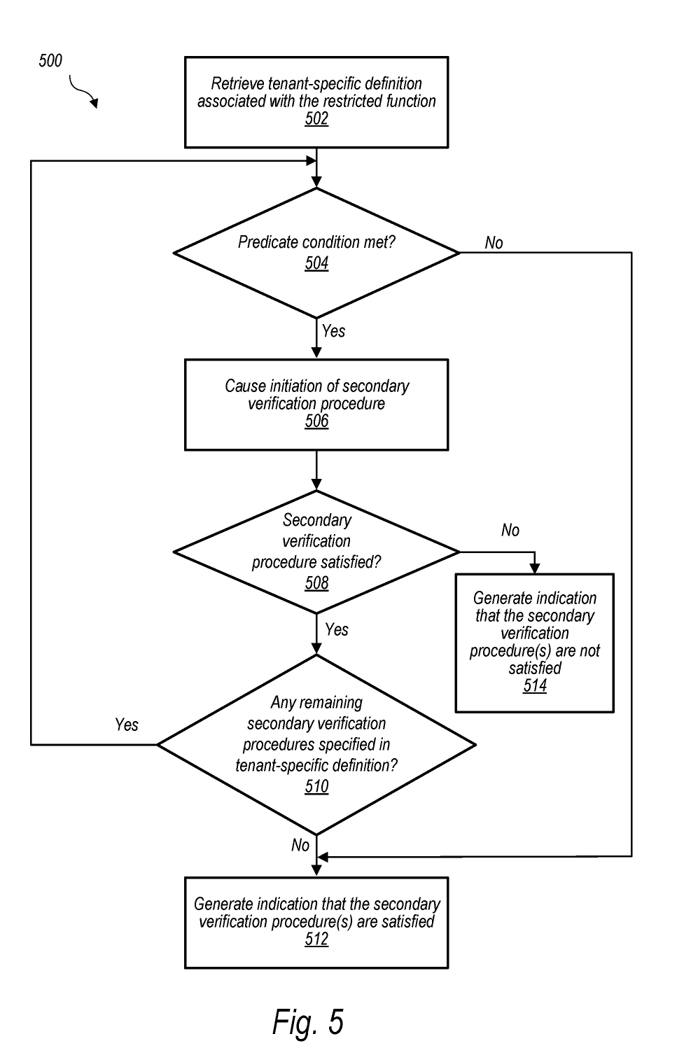

Element 408 includes, as described in more detail below with reference to FIG. 5, determining whether to authorize access to the restricted function. Method 400 then proceeds to element 410, which includes determining whether all of the applicable secondary verification procedures are satisfied. For example, as shown in FIG. 2, multiple secondary verification procedures 204 may be specified for a given restricted function 200. At element 410, MTCS 100 may determine whether each of the secondary verification procedures 204 that were performed, in response to their respective predicate conditions 202 being met, were satisfied. In response to a requesting user not satisfying one or more of the secondary verification procedures specified by the tenant-specific definition, method 400 proceeds to element 414, which includes denying the user's access to the restricted function. If, however, each of the secondary verification procedures 204 that are triggered are also satisfied, method 400 proceeds to element 412, which includes providing the requesting user with access to the restricted function.

Referring now to FIG. 5, a flow diagram of an example method 500 for determining whether to authorize access to a restricted function is depicted, according to some embodiments. Method 500 may be implemented, for example, as part of element 408 of FIG. 4. FIG. 5 includes elements 502-514. While these elements are shown in a particular order for ease of understanding, other orders may be used. For example, in various embodiments, some of the method elements may be performed concurrently, in a different order than shown, or may be omitted. Further, additional method elements may also be performed as desired.

To aid in the description of FIG. 5, consider an example embodiment in which tenant 114A specifies a tenant-specific definition 106 associated with a restricted function 200B (e.g., a function that allows a user to generate database reports) of MTCS 100. Specifically, assume that tenant 114A specifies two predicate conditions 202 and two corresponding secondary verification procedures 204 for restricted function 200B as follows. First, tenant 114A specifies that, in response to a user 112 satisfying predicate condition 202B (e.g., attempting to access restricted function 200B from a restricted IP address), the user 112 must satisfy secondary verification procedure 204B (e.g., providing authentication credentials) before being provided with access to restricted function 200B. Second, tenant 114A specifies that, in response to a user 112 satisfying predicate condition 202C (e.g., attempting to access restricted function 200B between the hours of 12:00 AM and 05:00 AM), the user 112 must satisfy secondary verification procedure 204C (e.g., providing a security code sent to the email address of the user 112) before being provided with access to restricted function 200B.

Note that this example is provided merely for ease of understanding and is not intended to limit the scope of the present disclosure. As noted above, any suitable combination of predicate conditions 202 or secondary verification procedures 204 may be used in various embodiments. Further, the disclosed methods and systems are not limited to the predicate conditions 202 or secondary verification procedures 204 provided herein. Rather, as one of ordinary skill in the art with the benefit of this disclosure will understand, predicate conditions 202 or secondary verification procedures 204 may, in various embodiments, be customized to address the specific needs of a given tenant.

In the depicted embodiment, method 500 begins with element 502, which includes retrieving one or more tenant-specific definitions associated with a restricted function. For example, in response to an attempt by a user 112A-112C of tenant 114A to access restricted function 200B, MTCS 100 may retrieve information associated with the secondary verification procedures 204 specified in definition 214A.

Method 500 then proceeds to element 504, which includes determining whether one or more predicate conditions are met. In various embodiments, element 504 may include comparing the criteria specified in the one or more predicate conditions against the circumstances of the attempted access. If none of the predicate conditions specified in the tenant-specific definition for the given restricted function are met at element 504, method 500 proceeds to element 512, which includes generating an indication that the secondary verification procedures are satisfied. For example, if user 112A attempts to access restricted function 200B from an authorized IP address during an authorized time period, neither of the predicate conditions 202B or 202C will be satisfied and, accordingly, MTCS 100 will not cause the initiation of any secondary verification procedures 204. Rather, since user 112A will have already satisfied the initial verification procedure (as described with reference to FIG. 4) and none of the predicate conditions are met, MTCS 100 may provide user 112A with access to restricted function 200B without causing initiation of any secondary verification procedure 204.

If, however, one or more of the predicate conditions specified in the tenant-specific definition for the given restricted function are met at element 504, method 500 proceeds to element 506, which includes causing the initiation of a secondary verification procedure. For example, if both users 112B and 112C attempt to access restricted function 200B from an unauthorized IP address, MTCS 100 will cause initiation of secondary verification procedure 204B at element 506.

Note that, in some embodiments, the secondary verification procedure 204 may be performed by the MTCS 100 itself. In the present example, MTCS 100 may, at element 506, perform secondary verification procedure 204B by sending a request for authentication credentials (e.g., as part of a webpage) to users 112B and 112C. In other embodiments, however, the secondary verification procedure 204 may be performed by a third-party on behalf of the MTCS 100, the given tenant 114, etc. For example, in one embodiment, secondary verification procedures 204 for one or more tenant 114 may be implemented by a third-party authentication server (not shown in FIG. 1). In embodiments in which one or more secondary verification procedures 204 are performed by a third party, MTCS 100 may be said to “cause initiation” of the secondary verification procedures 204 in various manners, including, for example, by sending a request or other indication to the third party, redirecting the user 112 to a website of the third party (e.g., via a redirect URI), etc.

Method 500 then proceeds to element 508, which includes determining whether the secondary verification procedure triggered at element 504 is satisfied. If, at element 508, the secondary verification procedure 204 is not satisfied, method 500 proceeds to element 514, which includes generating an indication that the secondary verification procedure(s) are not satisfied. For example, if user 112B does not satisfy secondary verification procedure 204B (e.g., provide valid authentication credentials), MTCS 100 may generate, at element 514, an indication that secondary verification procedure 204B is not satisfied and deny access (e.g., at element 414 of FIG. 5) to restricted function 200B to user 112B. Thus, in some embodiments, MTCS 100 may deny access to the restricted function 200 in response to the requesting user 112 not satisfying the secondary verification procedure 204. If, however, at element 508, it is determined that the secondary verification procedure 204 is satisfied, method 500 proceeds to element 510. For example, method 500 may proceed to element 510 in response to a determination that user 112C successfully satisfied secondary verification procedure 204B.

Element 510 includes determining whether there are any remaining secondary verification procedures are specified for the restricted function in the tenant-specific definition. If there are no remaining secondary verification procedures 204 for the restricted function 200 specified in the tenant-specific definition 106, method 500 proceeds to element 512, which includes generating an indication that the secondary verification procedure(s) 204 for the restricted function 200 have been satisfied. If, however, at element 510, it is determined that there are additional secondary verification procedures 204 specified for the restricted function 200, method 500 may proceed to elements 504-508. For example, with reference to user 112C's attempted access of restricted function 200B, MTCS 100 may determine that a second predicate condition 202 (e.g., predicate condition 202C) is specified by definition 214A for restricted function 200B. In such an embodiment, method 500 may repeat elements 504-508, as discussed above. For example, if user 112C attempts to access restricted function 200B at during an unauthorized time period, MTCS 100 may determine at element 504 that the second predicate condition (e.g., predicate condition 202C) is met. Method 500 may then continue to element 506, in which MTCS 100 may cause initiation of secondary verification procedure 204C in response to predicate condition 202C being met.

Note that, in some embodiments, a tenant 114 may simply wish to block a user 112's access to a particular restricted function 200 if a particular predicate condition 202 is satisfied. In such embodiments, method 500 may proceed from element 504 to element 514 in response such a predicate condition 202 being satisfied.

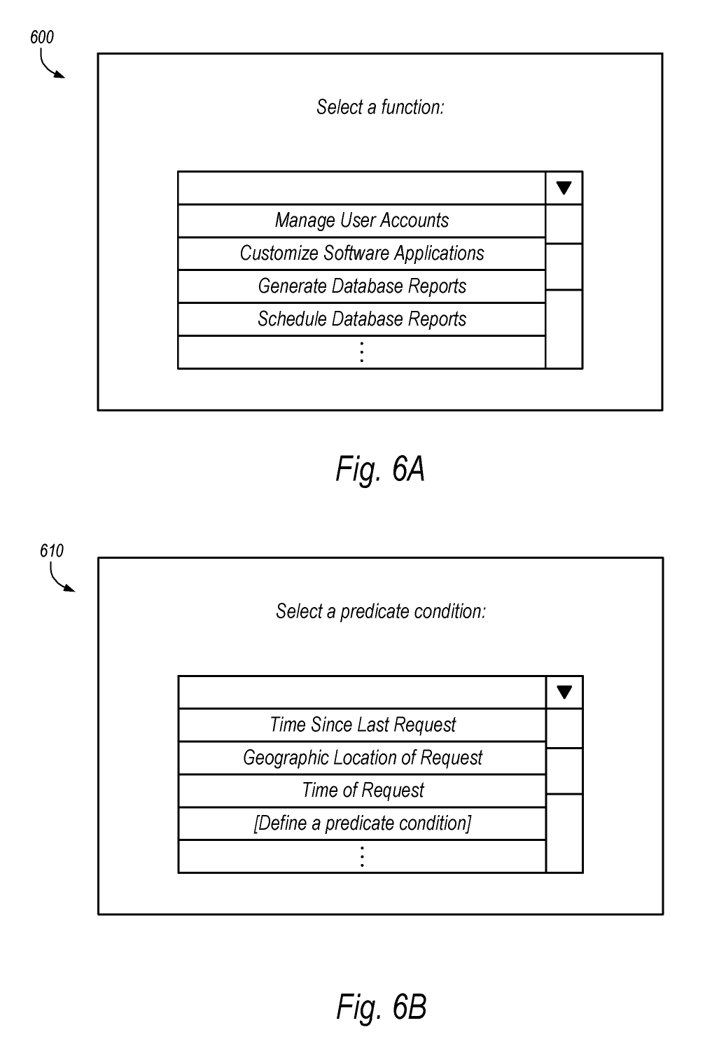

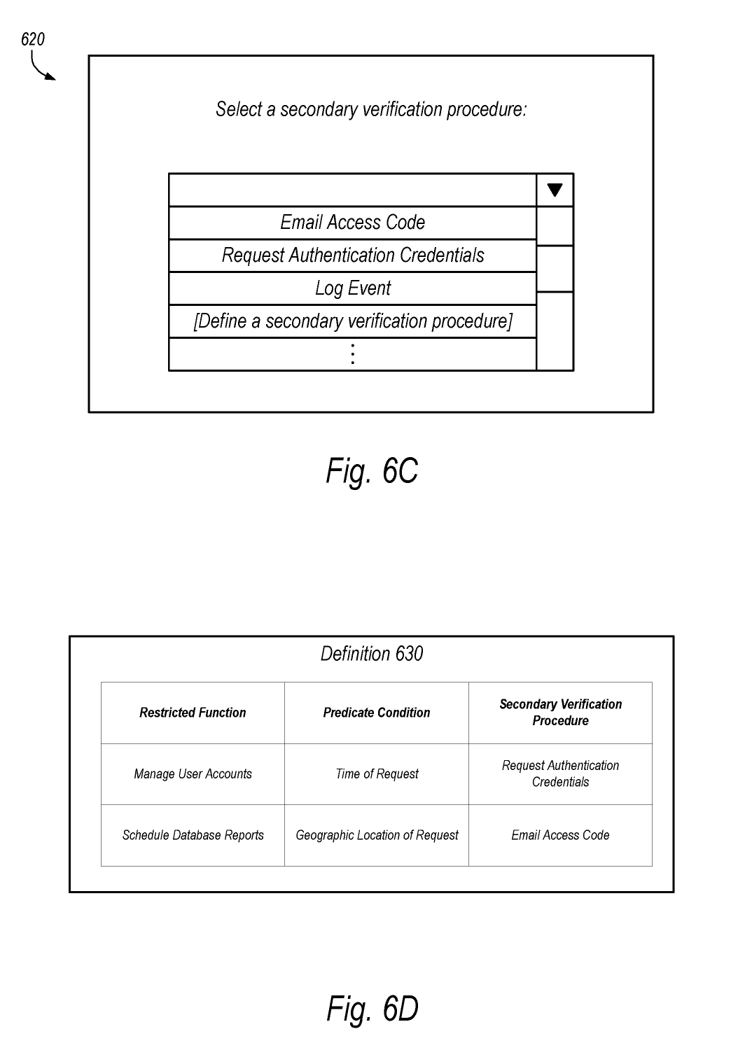

Turning now to FIGS. 6A-6D, an example tenant-specific definition of a secondary verification procedure is depicted, according to some embodiments. More specifically, FIGS. 6A-6C depict example interfaces 600-620 for specifying a secondary verification procedure that may be used, for example, by one or more of tenants 114 of FIG. 1. Further, FIG. 6D depicts an example definition 630 that may be specified, for example, by a tenant 114 using interfaces 600-620.

In FIG. 6A, an example interface 600 is shown, which may be used, for example, by a tenant 114 to specify one or more tenant-specific definitions 106 for one or more restricted functions 200 provided by MTCS 100. As shown in FIG. 6A, interface 600 provides a drop-down list of functions that a user 112 of a tenant 114 may select a restricted function 200 for which to add a secondary verification procedure 204.

Further, an interface 610, depicted in FIG. 6B, may be provided to user 112, requesting user 112 to specify a predicate condition 202 that will trigger the initiation of a secondary verification procedure 204 for the restricted function 200. For example, as shown in FIG. 6B, interface 610 may provide a user 112 with various predicate conditions 202 that may be used to trigger the initiation of a secondary verification procedure 204. In the depicted embodiment, the predicate conditions 202 presented include “time since last request,” “geographic location of request,” and “time of request.” Note, however, that these are merely provided as examples and any suitable predicate condition 202 may be used in various embodiments. Further, as shown in FIG. 6B, interface 610 includes an option for a user 112 to define a predicate condition 202. For example, user 112A of tenant 114A may select the “define a predicate condition” option to define a custom predicate condition that is suited to the needs of tenant 114A. One of ordinary skill in the art with the benefit of this disclose will recognize that a user 112 may define a predicate condition in various manners without departing from the scope of this disclosure. For example, in one embodiment, in response to selecting the “define a predicate condition” option, user 112 may be presented with an interface 615 (not shown) in which user 112 may supply program code (e.g., provided in Apex, Java, C++, or any other suitable programming language) specifying a custom predicate condition for the given restricted function 200.

User 112 may also be presented with an interface 620, depicted in FIG. 6C, which may be used to specify a secondary verification procedure 204 to implement in response to the predicate condition 202 being satisfied. For example, as shown in FIG. 6C, interface 620 may provide a user 112 with various secondary verification procedures 204 that may be performed in response to a predicate condition 202 being satisfied. In the depicted embodiment, the secondary verification procedures 204 presented include “email access code,” request authentication credentials,” and “log event.” Note, however, that these are merely provided as examples and any suitable secondary verification procedure 204 may be used in various embodiments. Further, as shown in FIG. 6C, interface 620 includes an option for user 112 to define a secondary verification procedure 204. For example, user 112A of tenant 114A may select the “define a secondary verification procedure” option to define a custom secondary verification procedure 204 that is suited to the needs of tenant 114A. As noted above with reference to FIG. 6B, one of ordinary skill in the art with the benefit of this disclose will recognize that a user 112 may define a secondary verification procedure in various manners without departing from the scope of this disclosure. For example, in one embodiment, in response to selecting the “define a secondary verification procedure” option, user 112 may be presented with an interface 625 (not shown) in which user 112 may supply program code (e.g., provided in Apex, Java, C++, or any other suitable programming language) specifying a custom secondary verification procedure for the given restricted function 200.

Referring now to FIG. 6D, an example definition 630 is shown. Definition 630 may represent a tenant-specific definition 106 specified by user 112A of tenant 114A using the interfaces 600-620 described above with reference to FIGS. 6A-6C. Specifically, definition 630 may specify secondary verification procedures 204 for two restricted functions 200. As depicted in FIG. 6D, user 112A may specify that for the restricted function 200 that allows the managing of user accounts, a secondary verification procedure 204 of requesting authentication credentials may be initiated in response to a predicate condition 202 that the request to access this function was received during a particular time period (e.g., after business hours). User 112A may further specify that for the restricted function 200 that allows the scheduling of database reports, the secondary verification procedure 204 of emailing the requesting user 112 an access code may be initiated in response to the predicate condition 202 that the request to access this function originated from a particular geographic location (e.g., outside of the United States).

### Example Computer System

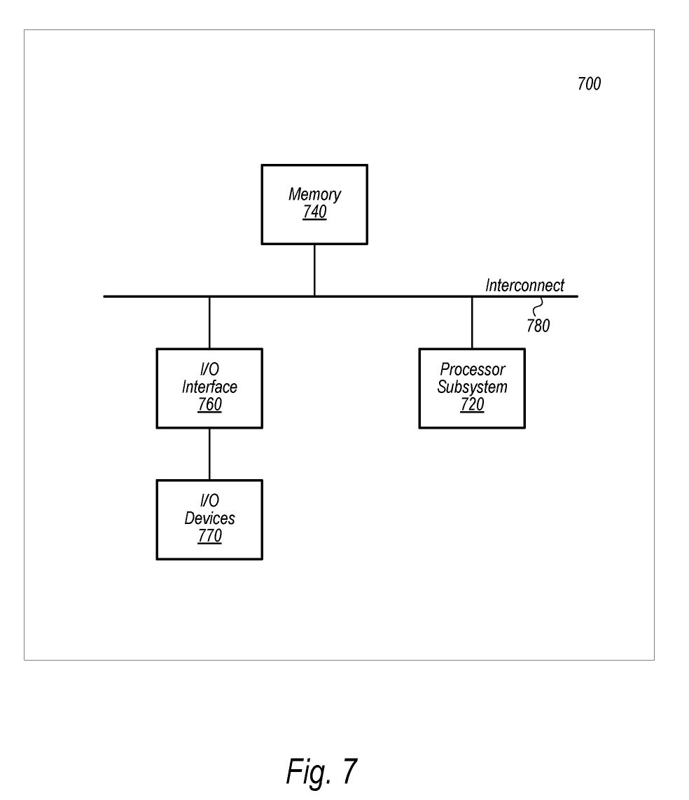

Turning now to FIG. 7, a block diagram of an example computer system 700 is depicted, which may implement one or more computer systems, such as an application server 102 of FIG. 1. Computer system 700 includes a processor subsystem 720 that is coupled to a system memory 740 and I/O interfaces(s) 760 via an interconnect 780 (e.g., a system bus). I/O interface(s) 760 is coupled to one or more I/O devices 770. Computer system 700 may be any of various types of devices, including, but not limited to, a server system, personal computer system, desktop computer, laptop or notebook computer, mainframe computer system, server computer system operating in a datacenter facility, tablet computer, handheld computer, workstation, network computer, a consumer device such as a mobile phone, music player, or personal data assistant (PDA). Although a single computer system 700 is shown in FIG. 7 for convenience, computer system 700 may also be implemented as two or more computer systems operating together.

Processor subsystem 720 may include one or more processors or processing units. In various embodiments of computer system 700, multiple instances of processor subsystem 720 may be coupled to interconnect 780. In various embodiments, processor subsystem 720 (or each processor unit within 720) may contain a cache or other form of on-board memory.

System memory 740 is usable to store program instructions executable by processor subsystem 720 to cause system 700 perform various operations described herein. System memory 740 may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 700 is not limited to primary storage such as system memory 740. Rather, computer system 700 may also include other forms of storage such as cache memory in processor subsystem 720 and secondary storage on I/O devices 770 (e.g., a hard drive, storage array, etc.). In some embodiments, these other forms of storage may also store program instructions executable by processor subsystem 720.

I/O interfaces 760 may be any of various types of interfaces configured to couple to and communicate with other devices, according to various embodiments. In one embodiment, I/O interface 760 is a bridge chip (e.g., Southbridge) from a front-side to one or more back-side buses. I/O interfaces 760 may be coupled to one or more I/O devices 770 via one or more corresponding buses or other interfaces. Examples of I/O devices 770 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 770 includes a network interface device (e.g., configured to communicate over WiFi, Bluetooth, Ethernet, etc.), and computer system 700 is coupled to a network via the network interface device.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, if a tenant-specific definition includes six predicate conditions, the terms “first predicate condition” and “second predicate condition” can be used to refer to any two of the six predicate conditions, and not, for example, just a first two predicate conditions to be specified, satisfied, etc.

When used in the claims, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
storing, by a multi-tenant computer system, code executable to perform a plurality of functions, wherein at least one of the plurality of functions is a restricted function that requires an initial verification procedure in response to an access attempt, wherein the initial verification procedure is common to at least a first tenant and a second tenant of the multi-tenant computer system;
storing, by the multi-tenant computer system, first and second tenant-specific definitions for the restricted function, wherein the first and second tenant-specific definitions are respectively associated with and specified by the first tenant and the second tenant, wherein the first and second tenant-specific definitions specify different secondary verification procedures;
in response to an attempt by a user of the first tenant to access the restricted function, performing, by the multi-tenant computer system, the initial verification procedure and causing initiation of a secondary verification procedure specified by the first tenant-specific definition; and
in response to an attempt by a user of the second tenant to access the restricted function, performing, by the multi-tenant computer system, the initial verification procedure and causing initiation of a secondary verification procedure specified by the second tenant-specific definition.

2. The method of claim 1, further comprising:
in response to an attempt by a user of a third tenant of the multi-tenant computer system to access the restricted function, performing, by the multi-tenant computer system, the initial verification procedure; and
providing, by the multi-tenant computer system, the user of the third tenant with access to the restricted function without causing initiation of a secondary verification procedure, including by:
determining that the user of the third tenant satisfied the initial verification procedure; and
determining that there is not a tenant-specific definition for the restricted function specified by the third tenant.

3. The method of claim 1, wherein the first tenant-specific definition specifies:
a first predicate condition and a particular secondary verification procedure for the first tenant to be performed in response to the first predicate condition being met; and
a second, different predicate condition and a different secondary verification procedure for the first tenant to be performed in response to the second, different predicate condition being met.

4. The method of claim 3, further comprising:
in response to an attempt by a first user of the first tenant to access the restricted function, performing, by the multi-tenant computer system, the initial verification procedure; and
causing, by the multi-tenant computer system, initiation of the particular secondary verification procedure in response to the first predicate condition being met.

5. The method of claim 3, further comprising:
in response to an attempt by a second user of the first tenant to access the restricted function, performing, by the multi-tenant computer system, the initial verification procedure; and
causing, by the multi-tenant computer system, initiation of the different secondary verification procedure in response to the second, different predicate condition being met.

6. The method of claim 3, further comprising:
in response to an attempt by a third user of the first tenant to access the restricted function, performing, by the multi-tenant computer system, the initial verification procedure; and
providing, by the multi-tenant computer system, the third user of the first tenant with access to the restricted function without causing initiation of a secondary verification procedure, in response to:
a determination that the third user of the first tenant satisfied the initial verification procedure; and
a determination that neither the first predicate condition or the second, different predicate condition is met.

7. The method of claim 3, further comprising:
in response to an attempt by a first user of the first tenant to access the restricted function, performing, by the multi-tenant computer system, the initial verification procedure; and
causing, by the multi-tenant computer system, initiation of both the particular secondary verification procedure and the different secondary verification procedure in response to the first predicate condition and the second, different predicate condition being met.

8. The method of claim 1, wherein the restricted function is included in an application accessible to users of the first tenant and the second tenant.

9. The method of claim 1, wherein performing the initial verification procedure includes performing a permissions check against a set of access permissions of a user attempting to access the restricted function.

10. The method of claim 1, further comprising:
in response to the user of the first tenant not satisfying the secondary verification procedure specified by the first tenant-specific definition, denying, by the multi-tenant computer system, access to the restricted function.

11. A non-transitory computer-readable medium having computer instructions stored thereon that are capable of being executed by a multi-tenant computer system to cause operations comprising:
storing code executable to perform a plurality of functions, including a restricted function that requires an initial verification procedure in response to an access attempt, wherein the initial verification procedure is common to at least first and second tenants of the multi-tenant computer system;
storing first and second tenant-specific definitions for the restricted function, wherein the first and second tenant-specific definitions are respectively associated with and specified by first and second tenants of the multi-tenant computer system, wherein the first and second tenant-specific definitions specify different secondary verification procedures;
in response to an attempt by a user of the first tenant to access the restricted function:
performing the initial verification procedure for the user of the first tenant; and
in response to the user of the first tenant satisfying the initial verification procedure, causing initiation of a secondary verification procedure specified by the first tenant-specific definition; and
in response to an attempt by a user of the second tenant to access the restricted function:
performing the initial verification procedure for the user of the second tenant; and
in response to the user of the second tenant satisfying the initial verification procedure, causing initiation of a secondary verification procedure specified by the second tenant-specific definition.

12. The non-transitory, computer-readable medium of claim 11, wherein the first tenant-specific definition specifies:
a predicate condition; and
a particular secondary verification procedure for the first tenant to be performed if the predicate condition is met.

13. The non-transitory, computer-readable medium of claim 12, wherein the first tenant-specific definition further specifies:
a second predicate condition; and
another secondary verification procedure for the first tenant to be performed if the second predicate condition is met.

14. The non-transitory, computer-readable medium of claim 12, wherein the second tenant-specific definition specifies:
a second, different predicate condition; and
the particular secondary verification procedure for the second tenant to be performed if the second, different predicate condition is met.

15. The non-transitory, computer-readable medium of claim 12, wherein the operations further comprise:
in response to the user of the first tenant satisfying the initial verification procedure and the predicate condition not being satisfied, providing, by the multi-tenant computer system, the user of the first tenant with access to the restricted function.

16. The non-transitory, computer-readable medium of claim 11, wherein the operations further comprise:
in response to the user of the first tenant not satisfying the initial verification procedure, the multi-tenant computer system not causing initiation of the secondary verification procedure specified by the first tenant-specific definition.

17. A method, comprising:
storing, by a multi-tenant computer system, code executable to implement a service that includes a plurality of functions, including a restricted function that requires a requesting user to satisfy an initial verification procedure in response to an access attempt, wherein the initial verification procedure is common to at least first and second tenants of the multi-tenant computer system;
storing, by the multi-tenant computer system, first and second tenant-specific definitions associated with the restricted function, wherein the first and second tenant-specific definitions are respectively associated with and specified by the first and second tenants of the multi-tenant computer system, wherein the first and second tenant-specific definitions specify different secondary verification procedures;
receiving, by the multi-tenant computer system from a first user of the first tenant, a first request to access the restricted function;
in response to receiving the first request, determining, by the multi-tenant computer system, whether to authorize the first user to access the restricted function, including by:
performing the initial verification procedure; and
in response to the first user satisfying the initial verification procedure, causing initiation of a secondary verification procedure specified by the first tenant-specific definition;
receiving, by the multi-tenant computer system from a second user of the second tenant, a second request to access the restricted function;
in response to receiving the second request, determining, by the multi-tenant computer system, whether to authorize the second user to access the restricted function, including by:
performing the initial verification procedure; and
in response to the second user satisfying the initial verification procedure, causing initiation of a secondary verification procedure specified by the second tenant-specific definition.

18. The method of claim 17, wherein the first tenant-specific definition specifies:
a predicate condition; and
a particular secondary verification procedure for the first tenant to be performed if the predicate condition is met.

19. The method of claim 18, wherein the predicate condition specified by the first tenant-specific definition corresponds to a geographical location from which requests to access the restricted function originated.

20. The method of claim 17, wherein the restricted function allows a user to manage one or more user accounts of a particular tenant of the multi-tenant computer system.
